(19) United States
(12) Patent Application Publication
(10) Pub. No.: US 2025/0339989 A1
(43) Pub. Date: Nov. 6, 2025

(54) Machine Tool Device, Machine Tool and System

(71) Applicant: Robert Bosch GmbH, Stuttgart (DE)

(72) Inventors: Houman Ramezanian, Enntbaden (CH); Stefano Delfini, Bettlach (CH); Pascal Schnell, Bärschwil (CH)

(21) Appl. No.: 18/866,546

(22) PCT Filed: May 15, 2023
(86) PCT No.: PCT/EP2023/062900

§ 371 Date: Nov. 17, 2024

(30) Foreign Application Priority Data
May 23, 2022 (DE) 10 2022 205 095.9

(51) Int. Cl. B27B 5/32; B27G 19/04

(52) U.S. Cl. CPC B27B 5/32; B27G 19/04

(57) ABSTRACT

A machine tool device, in particular a hand-held circular saw device, includes (i) a clamping unit for fixing a tool, in particular a circular saw blade, (ii) a protective cover, which at least partly surrounds a tool holder region for the tool, and (iii) an actuation unit for actuating the clamping unit. The actuation unit has an operating element which can be moved at least to some degree along the protective cover for actuation.

### PRIOR ART

A machine tool device has already been proposed having a clamping unit for fixing a tool, having a protective cover which at least partly surrounds a tool holder region for the tool, and having an actuation unit for actuating the clamping unit.

### DISCLOSURE OF THE INVENTION

The invention is based on a machine tool device, in particular a hand-held circular saw device, having a clamping unit for fixing a tool, in particular a circular saw blade, having a protective cover which at least partly surrounds a tool holder region for the tool, and having an actuation unit for actuating the clamping unit.

It is proposed that the actuation unit comprises an operating element that is movable at least to some degree along the protective cover for actuation. The design of the machine tool device according to the invention advantageously allows a tool to be released particularly easily and quickly from a state in which it is fixed to the clamping unit. A tool can be changed particularly conveniently and quickly. A particularly fast workflow can be guaranteed. A particularly space-saving and at the same time safe actuation of the operating element can be achieved. Advantageously, an actuation unit, in particular an operating element, can be provided which can be operated in a particularly compact manner. This makes it particularly easy and effective to prevent damage to the actuation unit, and especially to the operating element. A particularly ergonomic actuation of the actuation unit, in particular of the operating element, can be achieved. Advantageously, it is possible to prevent an operator from being injured when operating the actuation unit.

The operating element is intended in particular for manual actuation by a user. Preferably, the operating element can be moved along the protective cover by rotating it about an operating element rotation axis. Preferably, the operating element for actuation is movable at least essentially parallel to a surface, in particular the outer surface, of the protective cover. Here, “essentially parallel” is to be understood in particular as an alignment of a direction relative to a reference direction, in particular in a plane, wherein the direction has a deviation relative to the reference direction of in particular less than 8°, advantageously less than 5° and particularly advantageously less than 2°. Preferably, the actuation unit comprises at least one lever arm, by means of which, in particular, the operating element can be moved about the operating element rotation axis. The operating element is preferably rotatably mounted on a part of the protective cover, preferably by means of the lever arm. Alternatively, it is also conceivable that the operating element, in particular the lever arm, can be moved, preferably rotatably, mounted on a housing element of the machine tool, which is in particular different from the protective cover, or the like. The operating element is preferably arranged at a distance from the protective cover. For actuation, the operating element is moveable, at least to some degree along the protective cover, preferably at a constant distance from the protective cover. Alternatively, however, it is also conceivable that the operating element rests against the protective cover, preferably through the protective cover, in particular the surface of the protective cover facing the operating element, is guidable along the protective cover during a movement. Preferably, only one operating element needs to be actuated to release the tool when the tool is fixed to the clamping unit.

In particular, the clamping unit can be operated without tools, preferably by means of the actuation unit. The clamping unit is preferably fixed, in particular non-rotatable, on a machine tool, in particular on an output spindle of an output unit of the machine tool. Alternatively, it is conceivable that the clamping unit is arranged on the machine tool, in particular on the output spindle so that it is releasable. The clamping unit is preferably provided for fastening the tool to the machine tool device, in particular without tools. The term “intended” should be understood to mean specially furnished, specially designed, and/or specially equipped. An object being “intended” for a specific function is understood to mean that the object fulfills and/or performs this specific function in at least one application and/or operating state. Preferably, the tool can be driven to rotate or oscillate, in particular about a rotation axis of a connection interface of the tool, especially when the tool is fixed to the clamping unit. Preferably, the tool can be driven by the output spindle, in particular in a fixed state on the machine tool by means of the clamping unit, preferably rotating or oscillating. The clamping unit comprises, in particular when viewed in a plane extending at least essentially perpendicular to an output axis of the output spindle, an outer contour which is designed to correspond with a contour of the connection interface. The term “essentially perpendicular” can be understood to mean an orientation of a direction relative to a reference direction, wherein, in particular viewed in a projection plane, the direction and the reference direction enclose an angle of 90° and the angle has a maximum deviation of in particular less than 8°, advantageously less than 5°, and particularly advantageously less than 2°. The contour of the connection interface results in particular from the course of an inner boundary contour and an outer boundary contour of the connection interface. The output axis preferably runs at least essentially parallel to the rotation axis of the connection interface when the tool is fixed to the clamping unit.

Preferably, the output unit is intended to transmit a rotational and/or oscillating movement about the output axis to the tool fixed to the output unit by means of the clamping unit. Preferably, the output unit is effectively connected to a drive unit of the machine tool in a manner already known to a person skilled in the art, in particular via at least one drive pinion of the drive unit. In particular, the output unit comprises at least one sleeve and/or at least one hollow shaft, in particular a hollow spindle, which forms the output spindle. The rotational and/or oscillating movement of the output unit can preferably be generated as a result of interaction between the output unit and the drive unit of the machine tool, which comprises at least one electric motor.

In a further aspect of the invention, which can be considered in particular on its own as well as in conjunction with other aspects of the invention, it is proposed that the machine tool device comprises at least one securing unit which blocks the actuation unit when the protective cover is at least partly open. Advantageously, a machine tool device with a particularly high level of operating safety can be provided. It is advantageous to counteract unintentional actuation of the actuation unit to release the tool from the clamping unit. It is advantageous to prevent the tool from falling when the clamping unit is released. A particularly low risk of injury for the user can be achieved. The advantage is that the tool can be changed quickly and easily with a particularly high level of user safety. The securing unit is preferably mechanical. Preferably, the actuation unit is blocked or released by the securing unit, in particular automatically, depending on a protective cover position of the protective cover. The securing unit can preferably be actuated as a function of the protective cover position, in particular automatically. In particular, the securing unit releases actuation of the actuation unit when the protective cover is closed, preferably automatically. The protective cover position indicates in particular whether the protective cover is at least partly open or closed. Alternatively, it is also conceivable that the securing unit is at least partly electrical. For example, it is conceivable that the securing unit has a detection unit for detecting a protective cover position. The detection unit can, for example, comprise a mechanical sensor, an optical sensor or another sensor that a person skilled in the art would consider useful for detecting the position of the protective cover. It is conceivable that the securing unit comprises a control unit, which is set up in particular to evaluate a signal from the detection unit and to block or release the actuation unit as a function of this. In particular, the control unit comprises at least one processor and one memory element, as well as an operating program stored on the memory element. The storage element is preferably designed as a digital storage medium, such as a hard disk or similar. It is also conceivable that the control unit of the securing unit is formed by a control unit of the machine tool.

It is further proposed that the operating element is movable about an operating element rotation axis, wherein a movement of the operating element about the operating element rotation axis can generate a movement of an actuating element of the clamping unit that is at least essentially parallel to the actuating element rotation axis. In particular, the operating element rotation axis runs at least essentially parallel to the output axis of the output spindle and/or the rotation axis of the connection interface of the tool when the tool is fixed to the clamping unit. A movement of the operating element for actuating the clamping unit preferably runs in a plane that is at least essentially perpendicular to the output axis and/or the rotation axis of the tool when the tool is fixed to the clamping unit. The actuating element is designed, for example, as a bolt, a pin or another actuating element that would appear useful to a person skilled in the art. The clamping unit preferably has at least two states, in particular a released state and a fastened state. In the released state, the tool is preferably removable from the clamping unit, in particular from an assembly position on the clamping unit, or can be arranged in the assembly position on the clamping unit. In the fastened state, the tool is fixed to the clamping unit in a state arranged on the clamping unit, in particular in the assembly position. By moving the actuating element of the clamping unit, the clamping unit can be transferred in particular from the fastened state to the released state or from the released state to the fastened state. A particularly ergonomic arrangement of the actuation unit can be realized. A particularly high level of operating convenience can be achieved in an advantageous manner.

It is further proposed that the actuation unit comprises a ramp-shaped actuating means. In particular, the actuating means is intended to interact with the actuating element of the clamping unit to actuate the clamping unit. Preferably, the actuating means is intended to transmit the movement of the operating element, in particular via the lever arm, to the actuating element of the clamping unit. The actuating means is preferably arranged on the lever arm. The actuating means is preferably connected to the operating element via the lever arm. Preferably, the actuating means is fastened to the lever arm, in particular in a non-rotatable manner, for example by means of a screw connection, a snap-in connection or the like. It is conceivable that the lever arm is designed in one or more parts. Alternatively, it is conceivable that the actuating means is at least partly integral with the lever arm. The term “at least one unit or object, in particular the lever arm, and at least one further unit or object, in particular the actuating means, are formed at least partly in one piece with one another” is to be understood in particular as meaning that at least one element of the unit or object is formed in one piece with at least one further element of the further unit or object. The term “one-piece” can be understood to mean at least materially bonded, for example by a welding process, an adhesive process, an injection molding process and/or another process that appears to the person skilled in the art to be useful, and/or advantageously formed in one piece, such as by production from a casting and/or by production in a single or multi-component injection molding process and advantageously from a single blank. The operating element is preferably fastened to the lever arm, in particular in a non-rotatable manner, for example by means of a screw connection, a snap-in connection or similar. Alternatively, it is also conceivable that the operating element is at least partly integral with the lever arm. In particular, the actuating means and the operating element are arranged at opposite ends of the lever arm. Advantageously, a movement of the operating element along the protective cover can be transferred particularly easily into a movement for actuating the clamping unit. A particularly uniform release of the clamping unit can be advantageously achieved.

It is also proposed that the actuation unit has an actuating means, in particular the aforementioned actuating means, which at least partly surrounds the operating element rotation axis. Preferably, the actuating means surrounds the operating element rotation axis at an angle of no more than 75°. Preferably, the angular range in which the actuating means surrounds the operating element rotation axis is at least 20°. A particularly convenient and smooth actuation of the clamping unit can be realized.

Furthermore, it is proposed that the clamping unit can be released by an actuation travel of the operating element along the protective cover of at least 40°, in particular about the operating element rotation axis. Preferably, the clamping unit can be released along the protective cover by an actuation travel of the operating element of at least 40° starting from an end position of the operating element in the fastened state of the clamping unit. Alternatively, however, it is also conceivable that the actuation unit is designed such that the actuation travel, in particular for releasing the clamping unit, is less than 40°, preferably starting from the end position of the operating element in the fastened state of the clamping unit. Preferably, an actuation travel of the operating element starting from an end position of the operating element in the released state of the clamping unit to generate the fastened state is smaller than the actuation travel to generate the released state starting from the end position of the operating element in the fastened state of the clamping unit. Advantageously, the clamping unit can be released particularly easily and quickly, wherein in particular at the same time an unintentional release of the clamping unit can be counteracted. Advantageously, tools can be changed particularly quickly and conveniently. Advantageously, a particularly high level of actuating comfort can be achieved when releasing the clamping unit.

In addition, it is proposed that an actuation travel of the operating element along the protective cover for actuating the clamping unit, in particular that already mentioned above, is a maximum of 75°, in particular about the operating element rotation axis. Preferably, the actuation travel of the operating element along the protective cover for releasing the clamping unit is a maximum of 75°, in particular about the operating element rotation axis, preferably starting from the end position of the operating element in the fastened state of the clamping unit. In an alternative version of the actuation unit, it is also conceivable that the actuation travel of the operating element along the protective cover for actuating the clamping unit, in particular for releasing the clamping unit from the fastened state, is more than 75°, in particular about the operating element rotation axis, for example a maximum of 90°, preferably a maximum of 135°, particularly preferably a maximum of 180°. The clamping unit can be released particularly quickly and conveniently. Advantageously, the space required for actuating, in particular releasing, the clamping unit can be kept to a minimum. Advantageously, a particularly compact actuation unit can be provided.

It is further proposed that the actuation travel has an idle travel of at least 20°, in particular about the operating element rotation axis. In particular, the idle travel extends from the end position of the operating element in the fastened state of the clamping unit. In particular, the actuation unit, preferably the actuating means, only exerts an actuating effect, in particular an actuating force, on the clamping unit, in particular the actuating element of the clamping unit, in a state of the actuating element arranged outside the idle travel. The clamping unit, in particular the actuating element, is preferably free from an actuating effect, in particular an actuating force, by the actuation unit, in particular the actuating means of the actuation unit, in a state of the operating element arranged within the idle travel. It is conceivable that the actuating means of the actuation unit is arranged at a distance from the actuating element of the clamping unit in a state of the operating element arranged within the idle travel. Alternatively, however, it is also conceivable that the actuating means of the actuation unit rests against the actuating element of the clamping unit in a state of the operating element arranged within the idle travel. Preferably, the actuating means, in particular a force transmission surface of the actuating element, is in contact with the actuating element of the clamping unit at least in a state of the operating element arranged outside the idle travel. Preferably, the actuating means, in particular the force transmission surface of the actuating element, exerts a force on the actuating element of the clamping unit for actuating, in particular for releasing, the clamping unit, at least in a state of the operating element arranged outside the idle travel. Advantageously, unintentional release of the clamping unit by the actuation unit can be counteracted simply and effectively by design. Advantageously, a particularly high level of occupational safety can be achieved.

Furthermore, it is proposed that the operating element is arranged on a side of the protective cover facing away from the tool holder region when viewed in the radial direction. The radial direction refers in particular to the operating element rotation axis. Advantageously, an actuation unit with a particularly favorable arrangement of the operating element in terms of operating safety can be provided. Advantageously, the operator can be prevented from reaching into the tool holder region, in particular into the tool. Advantageously, the risk of injury when operating the operating element can be kept particularly low. A particularly convenient operation of the operating element can be achieved.

It is also proposed that the operating element is arranged on a side of the protective cover facing away from an operating side in the fastened state of the clamping unit, in particular the previously mentioned state. Preferably, an operator is located on the operating side in at least one operating state. A main handle of the machine tool, in particular the machine tool device, or the like is preferably arranged on the operating side. Advantageously, the arrangement of the operating element according to the invention can counteract unintentional actuation, in particular releasing, of the clamping unit particularly easily and effectively, at least in one operating state.

It is also proposed that the securing unit comprises a locking element, wherein closing the protective cover moves the locking element into an unlocked position. The locking element is designed, for example, as a pin, a hook, a ramp-shaped element or any other locking element that would appear useful to a person skilled in the art. Preferably, the actuation unit can be actuated in the unlocked position of the locking element. Preferably, the operating element can be moved along the protective cover when the locking element is in the unlocked position. In particular, the actuation unit, preferably the operating element, is free from engagement, in particular the application of force, by the securing unit, preferably the locking element, in the unlocked position of the locking element. Preferably, the securing unit is actuatable by moving at least part of the protective cover. In particular, the locking element is movable by moving at least one part of the protective cover. Preferably, the locking element can be moved from an unlocked state to a locked state and/or from the locked state to the unlocked state by moving the at least one part of the protective cover. In the unlocked state, the locking element is in the unlocked position in particular. In the locked state, the locking element is in a locked position in particular. Preferably, the locking element can only be moved into the unlocked state when the protective cover is closed. Preferably, the securing unit is designed in such a way that the locking element automatically moves into the locked state when the protective cover is open, for example by means of a gravity-controlled mechanism, by means of a spring element or similar. Closing the protective cover can advantageously be used to unlock the securing unit. Advantageously, the actuation unit can be actuated automatically by closing the protective cover. A particularly high level of operating convenience can be achieved in an advantageous manner.

It is also proposed that the securing unit comprises a locking element in the form of a pin, in particular the aforementioned locking element, which engages in the actuation unit when the protective cover is at least partly open. Preferably, the locking element acts on the lever arm of the actuation unit when the protective cover is at least partly open. It is conceivable that the lever arm has a recess, a notch or the like in which the locking element is arranged in the locked state. In particular, the locking element blocks the movement of the operating element along the protective cover when the protective cover is at least partly open. Preferably, the locking element blocks a movement, in particular a rotation, of the lever arm in the locked state, in particular about the operating element rotation axis. Advantageously, actuation of the clamping unit by means of the actuation unit can be counteracted in a particularly effective and structurally simple manner and thus also against the tool falling out when the protective cover is at least partly open.

It is further proposed that the securing unit comprises a locking element, in particular the aforementioned locking element, which can be moved into an unlocked position, in particular the aforementioned unlocked position, or into a locked position, in particular the aforementioned locked position, by rotating it about a locking element rotation axis. For example, the securing unit, in particular the locking element, is rotatably mounted on a part of the protective cover, on the housing element of the machine tool or on another housing element of the machine tool. Advantageously, a particularly space-saving and smooth-running securing unit can be provided.

Furthermore, it is proposed that the rotation of the locking element can be generated by a movement of at least part of the protective cover. Preferably, the protective cover, in particular the at least one part of the protective cover, is arranged relative to the locking element in such a way that the at least one part strikes against the securing unit when the protective cover is closed and moves the locking element into the unlocked position. Alternatively, it is also conceivable that the securing unit, in particular at least the locking element, is mechanically, in particular operatively, preferably directly, connected to the protective cover, in particular to at least one part of the protective cover, irrespective of the protective cover position. A particularly simple and convenient actuation of the securing unit, which is advantageous in terms of operating safety, can be achieved.

It is further proposed that the protective cover has at least one upper part of the protective cover and one lower part of the protective cover, which is arranged so as to be rotatable relative to the upper part of the protective cover about a protective cover rotation axis. The upper part of the protective cover is preferably firmly connected to the housing element, the additional housing element or an additional housing element of the machine tool, in particular in a non-rotatable manner. The operating element preferably can be moved along the upper part of the protective cover to actuate the clamping unit. It is conceivable that the upper part of the protective cover comprises a ramp or the like, along which the operating element for actuating the clamping unit is movable. In particular, the ramp is mounted on a base body of the upper part of the protective cover. It is conceivable that the ramp is formed separately from the base body and is fastened to the base body, for example by means of a screw connection, a snap-in connection or the like, or that the ramp is formed in one piece with the base body. Alternatively, however, it is also conceivable that the upper part of the protective cover is free of a ramp. The upper part of the protective cover and the lower part of the protective cover at least partly surround the tool holder region. In particular, the lower part of the protective cover can be pivoted relative to the upper part of the protective cover between the open state of the protective cover and the closed state of the protective cover. The securing unit is preferably actuated by interaction, in particular a movement, of the lower part of the protective cover. Preferably, the lower part of the protective cover moves the locking element into the unlocked state when the protective cover is closed. Advantageously, the securing unit can be actuated by a relative movement of the lower part of the protective cover to the upper part of the protective cover, in particular automatically. A particularly high level of operating convenience can be achieved in an advantageous manner.

It is also proposed that the protective cover rotation axis is arranged at a distance from and at least essentially parallel to the operating element rotation axis. Alternatively, it is also conceivable that the protective cover rotation axis corresponds to the operating element rotation axis. The space required for the actuation unit and the protective cover can be kept particularly compact.

It is also proposed that the protective cover rotation axis is arranged at a distance from and at least essentially parallel to the locking element rotation axis. Advantageously, a particularly favorable force action chain can be achieved between the protective cover and the securing unit to actuate the securing unit. Advantageously, the securing unit can be actuated with very little force.

It is also proposed that the locking element rotation axis is arranged at a distance from and at least essentially parallel to the operating element rotation axis. Advantageously, the space required by the actuation unit and the securing unit can be kept particularly compact. Advantageously, a particularly favorable force action chain can be achieved between the securing unit and the actuation unit for locking and/or unlocking the actuation unit.

It is also proposed that the protective cover at least partly surrounds the securing unit. Preferably, the securing unit, in particular at least the locking element, is arranged on a side of the protective cover facing the tool holder region. Preferably, the securing unit, in particular at least the locking element, is arranged between the upper part of the protective cover and the lower part of the protective cover. Advantageously, the securing unit can be protected from damage, especially from direct impacts. The arrangement of the securing unit according to the invention makes it particularly easy and effective to counteract unintentional unlocking of the securing unit.

Furthermore, a machine tool, in particular a hand-held circular saw, with a machine tool device according to the invention is proposed. The machine tool is preferably designed as a portable machine tool, in particular as a hand-held machine tool. The term “portable machine tool” is understood in this context to mean a machine tool for machining workpieces and able to be transported by an operator without the need for a transport machine. In particular, the portable machine tool has a mass that is less than 40 kg, preferably less than 10 kg, and more preferably less than 5 kg. Preferably, the machine tool is designed as a hand-held circular saw. However, it is also conceivable that the machine tool has a different configuration that would appear useful to a person skilled in the art, such as a configuration as an angle grinder, as a circular table saw, as an oscillating machine tool, as a grinding machine or the like. The embodiment according to the invention can advantageously provide a machine tool which enables particularly rapid releasing and changing of tools on the machine tool. A particularly efficient workflow can be realized.

Furthermore, a system with a tool, in particular a circular saw blade, and with a machine tool according to the invention is proposed. As an alternative to being designed as a circular saw blade, it is also conceivable that the tool is designed as a grinding wheel, a cutting wheel, a polishing wheel or any other tool that would appear useful to a person skilled in the art. Advantageously, a system can be provided that enables the tool to be released from the machine tool particularly quickly and easily. Tools can be exchanged particularly quickly and conveniently. It is advantageous to be able to work particularly efficiently with the machine tool.

The machine tool device according to the invention, the machine tool according to the invention and/or the system according to the invention should not be limited to the application and embodiment described above. In particular, the machine tool device according to the invention, the machine tool according to the invention and/or the system according to the invention may have a number of individual elements, components and units that differs from a number specified herein in order to fulfill a mode of operation described herein. Moreover, regarding the ranges of values indicated in this disclosure, values lying within the limits specified hereinabove are also intended to be considered as disclosed and usable as desired.

### DRAWINGS

Further advantages emerge from the following description of the drawings. An exemplary embodiment of the invention is shown in the drawing. The drawings, the description, and the claims contain numerous features in combination. A person skilled in the art will appropriately also consider the features individually and combine them into additional advantageous combinations.

Shown are:

FIG. 1 a schematic view of a system according to the invention with a machine tool according to the invention and a tool arranged on the machine tool,

FIG. 2 an exploded perspective view of a machine tool device according to the invention of the machine tool according to the invention,

FIG. 3 a perspective sectional view of the machine tool from FIG. 1

FIG. 4 a schematic front view of a part of the machine tool according to the invention without the tool in an unlocked state of a securing unit of the machine tool device according to the invention,

FIG. 5 a schematic, perspective rear view of a part of the machine tool according to the invention with the tool in the unlocked state of the securing unit,

FIG. 6 a schematic front view of the part of the machine tool according to the invention without the tool in a locked state of the securing unit and

FIG. 7 a schematic, perspective rear view of a part of the machine tool according to the invention with the tool in the locked state of the securing unit.

### DESCRIPTION OF THE EXEMPLARY EMBODIMENT

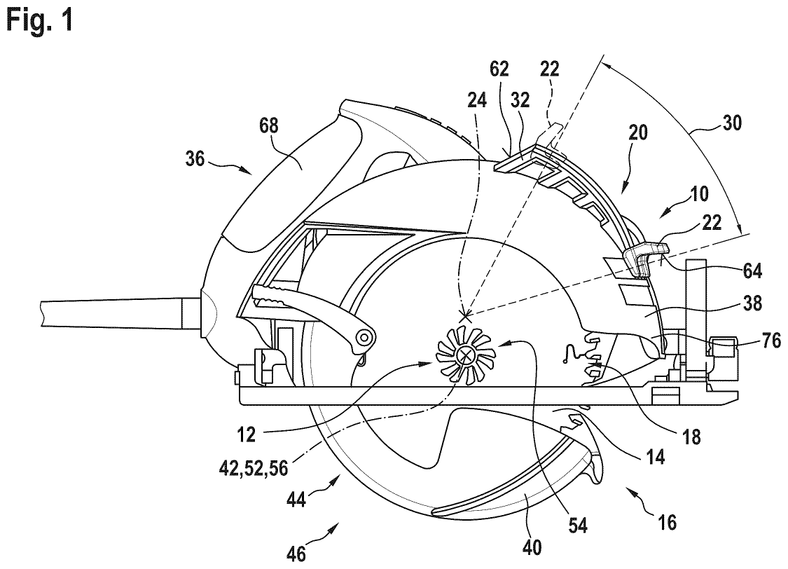

FIG. 1 shows a system 46 with a tool 14 and a machine tool 44. The machine tool 44 is designed as a portable machine tool, in particular as a hand-held machine tool. The machine tool 44 is designed as a hand-held circular saw. However, it is also conceivable that the machine tool 44 has another configuration that would appear to a person skilled in the art to be useful, such as a configuration as an angle grinder, as a circular table saw, as an oscillating machine tool, as a grinding machine or the like. The tool 14 is designed as a circular saw blade. Alternatively, it is also conceivable that the tool 14 is designed as a grinding wheel, as a cutting wheel, as a polishing wheel or as another tool 14 that would appear useful to a person skilled in the art.

The machine tool 44 comprises a machine tool device 10. The machine tool device 10 comprises a clamping unit 12 for fixing the tool 14. The clamping unit 12 can be operated without tools. The machine tool device 10 comprises an actuation unit 20 for actuating the clamping unit 12, in particular without tools. The clamping unit 12 is fixed, in particular non-rotatably, on the machine tool 44, in particular on an output spindle of an output unit of the machine tool 44. Alternatively, it is conceivable that the clamping unit 12 is arranged on the machine tool 44, in particular on the output spindle, so that it is releasable. The clamping unit 12 is provided for fastening the tool 14 to the machine tool device 10, in particular without tools. In a state fixed to the clamping unit 12, the tool 14 can be driven to rotate or oscillate, in particular about a rotation axis 52 of a connection interface 54 of the tool 14. The tool 14 can be driven by the output spindle in a state fixed to the machine tool 44 by means of the clamping unit 12, preferably rotating or oscillating. The clamping unit 12 has, in particular when viewed in a plane extending at least essentially perpendicular to an output axis 56 of the output spindle, an outer contour which is designed to correspond with a contour of the connection interface 54. The contour of the connection interface 54 results from a course of an inner boundary contour and an outer boundary contour of the connection interface 54. In a state in which the tool 14 is fixed to the clamping unit 12, the output axis 56 runs at least essentially parallel to the rotation axis 52 of the connection interface 54. When the tool 14 is fixed to the clamping unit 12, the output axis 56 corresponds to the rotation axis 52 of the connection interface 54.

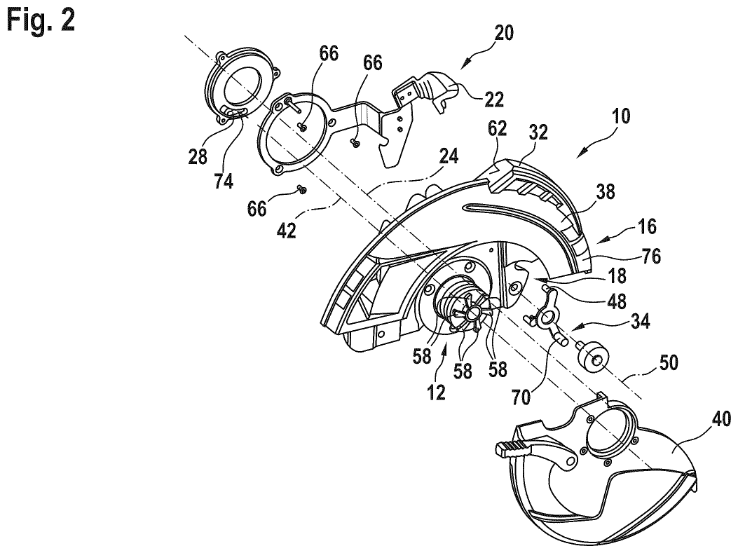

The clamping unit 12 is designed here as a quick-clamping device, as disclosed for example in WO 2021/130026 A1, but with six retaining wings corresponding to the connection interface 54 (see also FIG. 2). The disclosure content of WO 2021/130026 A1 with regard to the quick-action clamping device disclosed therein is to be regarded in particular as part of the present description with regard to the design of the clamping unit 12. Alternatively, however, it is also conceivable that the clamping unit 12 is designed with four retaining wings in accordance with the quick-clamping device from WO 2021/130026 A1, is designed as a quick-clamping device as disclosed, for example, in DE 10 2017 213 669 A1, or is designed as another quick-clamping device that appears to a person skilled in the art to be useful.

The output unit is intended to transmit a rotational and/or oscillating movement about the output axis 56 to the tool 14, which is fixed to the output unit by means of the clamping unit 12. The output unit is operatively connected to a drive unit of the machine tool 44 in a manner already known to a person skilled in the art, in particular via at least one drive pinion of the drive unit. In particular, the output unit comprises at least one sleeve and/or at least one hollow shaft, in particular a hollow spindle, which forms the output spindle. The rotational and/or oscillatory movement of the output unit can preferably be generated as a result of interaction of the output unit with the drive unit of the machine tool 44, which comprises at least one electric motor.

The machine tool device 10 comprises a protective cover 16 which at least partly surrounds a tool holder region 18 for the tool 14. The actuation unit 20 has an operating element 22, which can be moved at least to some degree along the protective cover 16 for actuation. The operating element 22 is intended for manual actuation by a user. The operating element 22 can be moved about an operating element rotation axis 24. The operating element 22 can be moved along the protective cover 16 by rotating it about the operating element rotation axis 24. For actuation, the operating element 22 can be moved at least essentially parallel to a surface 58, in particular the outer surface, of the protective cover 16.

The actuation unit 20 comprises at least one lever arm 60. By means of the lever arm 60, the operating element 22 can be moved about the operating element rotation axis 24. The operating element 22 is rotatably mounted on a part of the protective cover 16, in particular on an upper part of the protective cover 38 of the protective cover 16, in particular by means of the lever arm 60. The operating element 22 can be moved along the upper part of the protective cover 38 to actuate the clamping unit 12. Alternatively, it is also conceivable that the operating element 22, in particular the lever arm 60, can be moved, preferably rotatably, mounted on a housing element of the machine tool 44, which is in particular different from the protective cover 16, or the like. The operating element 22 is arranged at a distance from the protective cover 16, in particular the upper part of the protective cover 38. The operating element 22 can be moved at least to some degree along the protective cover 16, in particular the upper part of the protective cover 38, for actuation at a constant distance from the protective cover 16, in particular the upper part of the protective cover 38. Alternatively, however, it is also conceivable that the operating element 22 rests against the protective cover 16, in particular can be guided by the protective cover 16, preferably the surface 58 of the protective cover 16 facing the operating element 22, during a movement along the protective cover 16, in particular the upper part of the protective cover 38. To release the tool 14 from a fixed state on the clamping unit 12, only the one operating element 22 needs to be actuated.

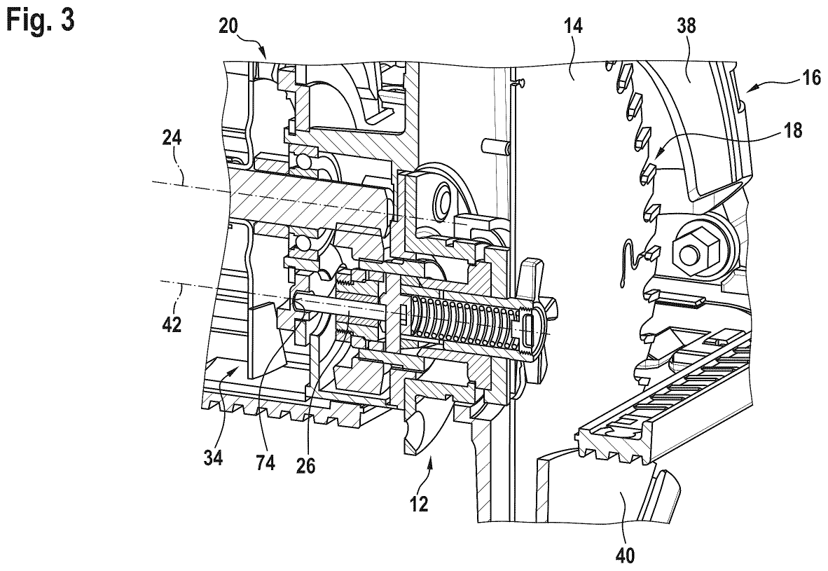

By moving the operating element 22 about the operating element rotation axis 24, a movement of an actuating element 26 of the clamping unit 12 that is at least essentially parallel to the operating element rotation axis 24 can be generated (see also FIG. 3). The operating element rotation axis 24 extends at least essentially parallel to the output axis 56 of the output spindle and/or the rotation axis 52 of the connection interface 54 of the tool 14 in a state of the tool 14 fixed to the clamping unit 12. A movement of the operating element 22 for actuating the clamping unit 12 extends in a plane which is at least essentially perpendicular to the output axis 56 and/or the rotation axis 52 of the tool 14 in a state of the tool 14 fixed to the clamping unit 12.

The actuating element 26 is designed, for example, as a bolt, as a pin or as another actuating element 26 which appears to a person skilled in the art to be useful. The clamping unit 12 has at least two states, in particular a released state and a fastened state. In the released state, the tool 14 can be removed from the clamping unit 12, in particular from an assembly position on the clamping unit 12, or can be arranged in the assembly position on the clamping unit 12. In the fastened state of the clamping unit 12, the tool 14 is fixed to the clamping unit 12 in a state arranged on the clamping unit 12, in particular in the assembly position. By moving the actuating element 26 of the clamping unit 12, the clamping unit 12 can be transferred from the fastened state to the released state or from the released state to the fastened state.

FIG. 1 shows the actuation unit 20, in particular the operating element 22, in two different positions. The representation of the operating element 22 with solid lines corresponds to the fastened state of the clamping unit 12, wherein the operating element 22 is in an end position of the operating element 22 in the fastened state of the clamping unit 12. The dashed representation of the operating element 22 corresponds to the released state of the clamping unit 12, wherein the operating element 22 is in an end position of the operating element 22 in the released state of the clamping unit 12. It is also conceivable that the actuation unit 20 has a spring element which applies a force to the operating element 22 in the direction of the end position of the operating element 22 in the fastened state of the clamping unit 12.

The actuation unit 20 comprises a ramp-shaped actuating means 28. The actuating means 28 is intended to interact with the actuating element 26 of the clamping unit 12 to actuate the clamping unit 12. The actuating means 28 is intended to transmit the movement of the operating element 22, in particular via the lever arm 60, to the actuating element 26 of the clamping unit 12. The actuating means 28 is arranged on the lever arm 60. The actuating means 28 is connected to the operating element 22 via the lever arm 60. The lever arm 60 is in two parts. Alternatively, however, it is also conceivable that the lever arm 60 is designed in one piece or is formed by more than two parts. The actuating means 28 is fastened to the lever arm 60 by means of screws 66. Alternatively, it is also conceivable that the actuating means 28 is fastened to the lever arm 60 by means of a latching connection, a riveted connection or the like, in particular in a rotationally fixed manner, or that the actuating means 28 is at least partly formed integrally with the lever arm 60. In particular, the actuating means 28 and the operating element 22 are arranged at opposite ends of the lever arm 60.

The actuating means 28 at least partly surrounds the operating element rotation axis 24. The actuating means 28 surrounds the operating element rotation axis 24 in an angular range of maximum 75°. The angular range in which the actuating means 28 surrounds the operating element rotation axis 24 is at least 20°.

The clamping unit 12 can be released by an actuation travel 30 of the operating element 22 along the protective cover 16 of at least 40°. The clamping unit 12 can be released by an actuation travel 30 of the operating element 22 starting from the end position of the operating element 22 in the fastened state of the clamping unit 12 along the protective cover 16, in particular the upper part of the protective cover 38, of at least 40°. Alternatively, however, it is also conceivable that the actuation unit 20 is designed such that the actuation travel 30, in particular for releasing the clamping unit 12, is less than 40° starting from the end position of the operating element 22 in the fastened state of the clamping unit 12. An actuation travel of the operating element 22 starting from the end position of the operating element 22 in the released state of the clamping unit 12 for generating the fastened state is in particular smaller than the actuation travel 30 for generating the released state starting from the end position of the operating element 22 in the fastened state of the clamping unit 12.

The actuation travel 30 of the operating element 22 along the protective cover 16 for actuating the clamping unit 12 is a maximum of 75°. The actuation travel 30 of the operating element 22 along the protective cover 16, in particular the upper part of the protective cover 38, for releasing the clamping unit 12 is a maximum of 75°, in particular about the operating element rotation axis 24, preferably starting from the end position of the operating element 22 in the fastened state of the clamping unit 12. Alternatively, it is also conceivable that the actuation travel 30 of the operating element 22 along the protective cover 16 for actuating the clamping unit 12, in particular for releasing the clamping unit 12 from the fastened state, is more than 75°, in particular about the operating element rotation axis 24, for example a maximum of 90°, preferably a maximum of 135°, particularly preferably a maximum of 180°.

The actuation travel 30 has an idle travel of at least 20°. The idle travel extends from the end position of the operating element 22 in the fastened state of the clamping unit 12. The actuation unit 20, in particular the actuating means 28, only exerts an actuating effect, in particular an actuating force, on the clamping unit 12, in particular the actuating element 26 of the clamping unit 12, in a state of the operating element 22 arranged outside the idle travel. The clamping unit 12, in particular the actuating element 26, is free from an actuating effect, in particular an actuating force, by the actuation unit 20, in particular the actuating means 28 of the actuation unit 20, in a state of the operating element 22 arranged within the idle travel. The actuating means 28, in particular a force transmission surface 74 of the actuating element 26, exerts a force on the actuating element 26 of the clamping unit 12 in a state of the operating element 22 arranged outside the idle travel.

Viewed in the radial direction, the operating element 22 is arranged on a side of the protective cover 16 facing away from the tool holder region 18. The radial direction refers in particular to the operating element rotation axis 24. In a fastened state of the clamping unit 12, the operating element 22 is arranged on a side of the protective cover 16 facing away from an operating side 36. An operator is located on the operating side 36 at least during proper operation of the machine tool 44. A main handle 68 of the machine tool 44, in particular of the machine tool device 10, is arranged on the operating side 36.

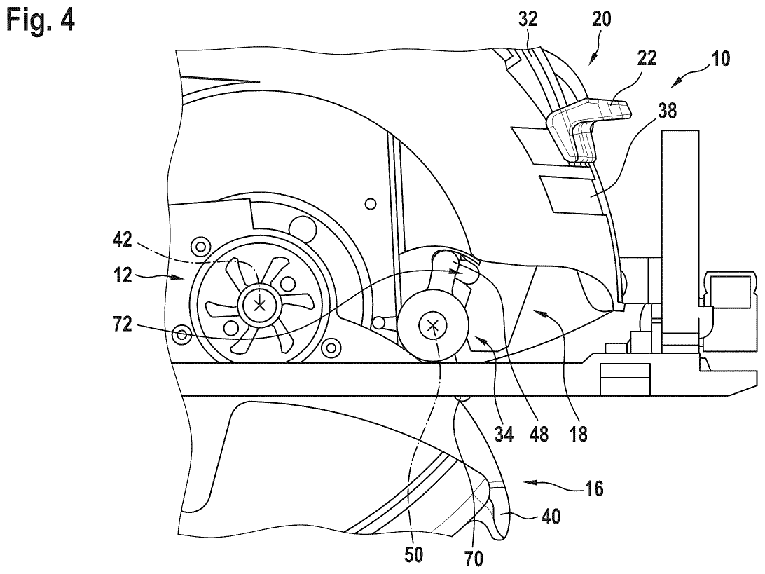

The machine tool device 10 comprises at least one securing unit 34, which blocks the actuation unit 20 when the protective cover 16 is at least partly open (see FIGS. 4 through 7). The securing unit 34 is mechanical. The actuation unit 20 is blocked or released by the securing unit 34, in particular automatically, depending on a protective cover position of the protective cover 16, in particular of a lower part of the protective cover 40 relative to the upper part of the protective cover 38. The lower part of the protective cover 40 is arranged rotatably relative to the upper part of the protective cover 38 about a protective cover rotation axis 42.

The upper part of the protective cover 38 is firmly connected to a housing element of the machine tool 44, in particular in a rotationally fixed manner. The upper part of the protective cover 38 has a ramp 32 along which the operating element 22 can be moved to actuate the clamping unit 12. The ramp 32 is mounted on a base body 76 of the upper part of the protective cover 38. It is conceivable that the ramp 32 is formed separately from the base body 76 and is fastened to the base body 76, for example by means of a screw connection, a snap-in connection or the like, or that the ramp 32 is formed in one piece with the base body 76. Alternatively, however, it is also conceivable that the upper part of the protective cover 38 is free of a ramp 32. The upper part of the protective cover 38 and the lower part of the protective cover 40 at least partly surround the tool holder region 18. The ramp 32 has a contact surface 62 for the operator to place the ball of his hand on when operating the operating element 22. The operating element 22 has a gripping surface 64 for placing the fingers of the operator when operating the operating element 22. To release the clamping unit 12, the operating element 22 can be moved from the end position in the fastened state of the clamping unit 12 in particular in the direction of the operating side 36, preferably into the end position of the operating element 22 in the released state of the clamping unit 12.

The lower part of the protective cover 40 can be pivoted relative to the upper part of the protective cover 38 between the at least partly open state of the protective cover 16 and the closed state of the protective cover 16. The securing unit 34 can be actuated as a function of the protective cover position, in particular automatically. The securing unit 34 releases actuation of the actuation unit 20 when the protective cover 16 is closed, in particular when the lower part of the protective cover 40 is closed, preferably automatically. The protective cover position indicates in particular whether the protective cover 16, in particular the lower part of the protective cover 40, is at least partly open or closed.

Alternatively, it is also conceivable that the securing unit 34 is at least partly electrical. Alternatively, for example, it is conceivable that the securing unit 34 has a detection unit for detecting the position of the protective cover. The detection unit can, for example, comprise a mechanical sensor, an optical sensor or another sensor that a person skilled in the art would consider useful for detecting the position of the protective cover. It is conceivable that the securing unit 34 comprises a control unit, which is set up in particular to evaluate a signal from the detection unit and to block or release the actuation unit 20 as a function thereof. In particular, the control unit comprises at least one processor and one memory element, as well as an operating program stored on the memory element. The storage element is preferably designed as a digital storage medium, such as a hard disk or similar. It is also conceivable that the control unit of the securing unit 34 is at least partly formed by a control unit of the machine tool 44.

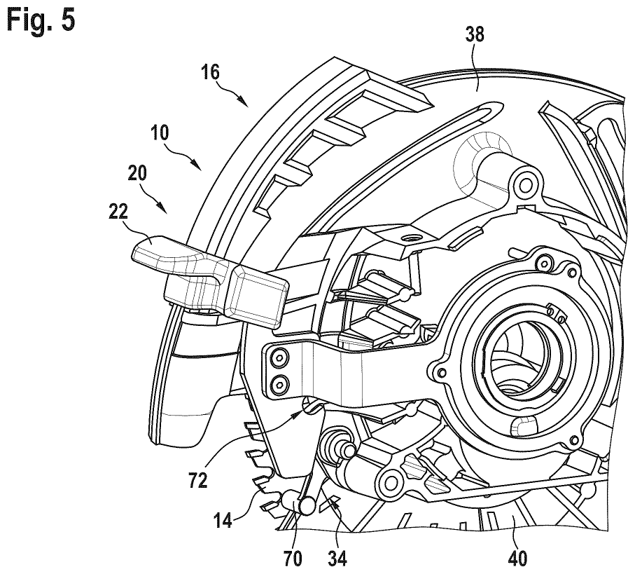

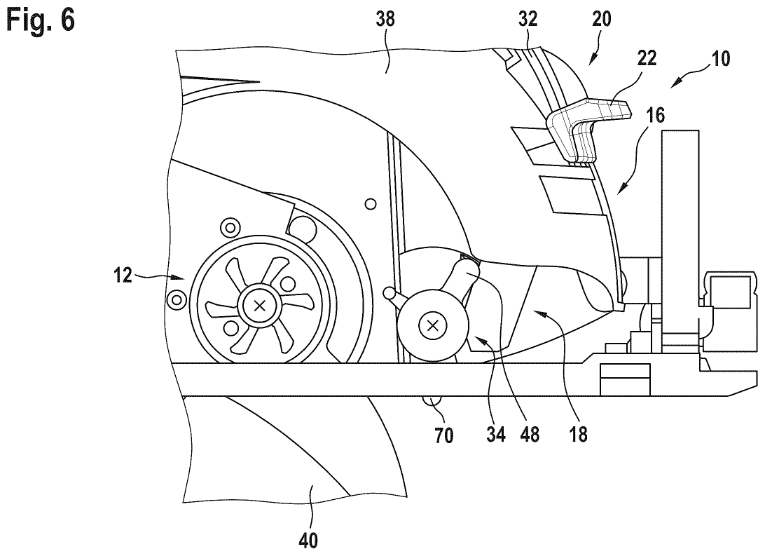

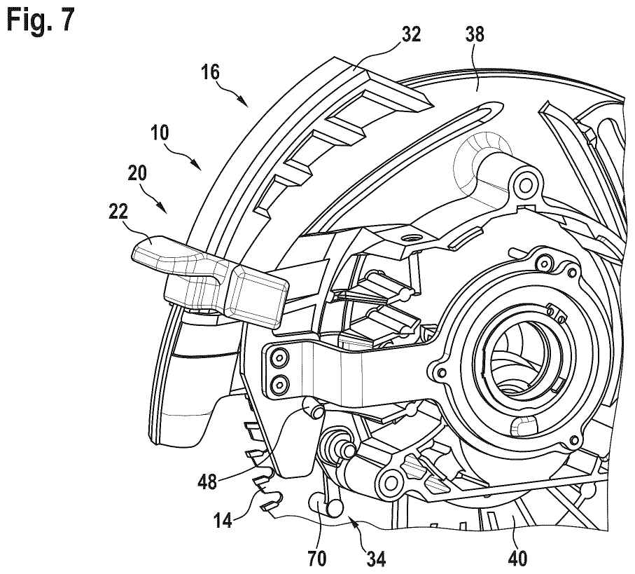

The securing unit 34 comprises a locking element 48. Closing the protective cover 16 moves the locking element 48 into an unlocked position. The locking element 48 is designed as a pin. Alternatively, it is also conceivable that the locking element 48 is designed as a hook, as a ramp-shaped element, or as another locking element 48 which appears to a person skilled in the art to be useful. The actuation unit 20 can be actuated in the unlocked position of the locking element 48. In FIGS. 4 and 5, the locking element 48 is in the unlocked position, wherein the lower part of the protective cover 40 is in particular closed and pressing against a stop pin 70 of the securing unit 34. In the unlocked state, the locking element 48 is in the unlocked position. In an unlocked state of the locking element 48, the operating element 22 can be moved along the protective cover 16, in particular along the upper part of the protective cover 38. In the unlocked state of the locking element 48, the actuation unit 20, in particular the operating element 22, is free from engagement, in particular the application of force, by the securing unit 34, in particular the locking element 48. The securing unit 34 can be actuated by moving at least a part of the protective cover 16, in particular the lower part of the protective cover 40, relative to the securing unit 34, preferably the locking element 48. The locking element 48 can be moved by moving the lower part of the protective cover 40. The locking element 48 can be moved from the unlocked state to a locked state and/or from the locked state to the unlocked state by a movement of the at least one part of the protective cover 16, in particular by a movement of the lower part of the protective cover 40 relative to the securing unit 34, preferably the locking element 48. In the locked state, the locking element 48 is in a locked position. In FIGS. 6 and 7, the locking element 48 is in the locked position, wherein the lower part of the protective cover 40 is at least partly open and the stop pin 70 of the securing unit 34 is free from the application of force by the lower part of the protective cover 40. The locking element 48 can only be moved into the unlocked position when the protective cover 16 is closed. Preferably, the securing unit 34 is designed such that the locking element 48 automatically moves into the locked state when the protective cover 16 is in the open state, for example by means of a gravity-controlled mechanism, by means of a spring element or the like.

The locking element 48 is designed as a pin. The locking element 48 engages in the actuation unit 20 when the protective cover 16 is at least partly open. The locking element 48 acts on the lever arm 60 of the actuation unit 20 when the protective cover 16 is at least partly open. The lever arm 60 has a recess 72 in which the locking element 48 is arranged in the locked state. When the protective cover 16 is at least partly open, the locking element 48 blocks the movement of the operating element 22 along the protective cover 16, in particular the upper part of the protective cover 38. In the locked state, the locking element 48 blocks a movement, in particular a rotation, of the lever arm 60, in particular about the operating element rotation axis 24.

By rotating the locking element 48 about a locking element rotation axis 50, the locking element 48 can be moved into the unlocked position or into the locked position. The securing unit 34, in particular the locking element 48, is rotatably mounted on the protective cover 16, in particular the upper part of the protective cover 38. Alternatively, however, it is also conceivable that the securing unit 34, in particular at least the locking element 48, is rotatably mounted on a housing element of the machine tool 44.

The rotation of the locking element 48 can be generated by a movement of at least part of the protective cover 16. The lower part of the protective cover 40 moves the locking element 48 into the unlocked state when the protective cover 16 is closed. The protective cover 16, in particular the lower part of the protective cover 40, is arranged relative to the locking element 48 in such a way that the lower part of the protective cover 40 strikes against the securing unit 34, in particular the stop pin 70, when the protective cover 16 is closed and moves the locking element 48 into the unlocked position. The stop pin 70 is firmly connected, in particular non-rotatably, to the locking element 48. In particular, the stop pin 70 is formed in one piece with the locking element 48. Alternatively, it is also conceivable that the securing unit 34, in particular at least the locking element 48, is mechanically, in particular operatively, preferably directly, connected to the protective cover 16, in particular the lower part of the protective cover 40, irrespective of the protective cover position.

The protective cover rotation axis 42 is spaced apart from and arranged at least essentially parallel to the locking element rotation axis 50 and/or the operating element rotation axis 24. Alternatively, it is also conceivable that the protective cover rotation axis 42 corresponds to the operating element rotation axis 24. The locking element rotation axis 50 is arranged at a distance from and at least essentially parallel to the operating element rotation axis 24.

The protective cover 16 at least partly surrounds the securing unit 34. The securing unit 34, in particular at least the locking element 48, is arranged on a side of the protective cover 16 facing the tool holder region 18. The securing unit 34, in particular at least the locking element 48, is arranged between the upper part of the protective cover 38 and the lower part of the protective cover 40.

1. A machine tool device, comprising:
a clamping unit configured to fix a tool;
a protective cover which at least partly surrounds a tool holder region for the tool; and
an actuation unit configured to actuate the clamping unit,
wherein the actuation unit has an operating element configured to be moved at least to some degree along the protective cover for actuation.

2. The machine tool device according to claim 1, wherein:
the operating element is configured to be moved about an operating element rotation axis, and
a movement of the operating element about the operating element rotation axis generates a movement of an actuating element of the clamping unit which runs at least essentially parallel to the operating element rotation axis.

3. The machine tool device according to claim 1, wherein the actuation unit has a ramp-shaped actuating mechanism.

4. The machine tool device according to claim 2, wherein the actuation unit has an actuating mechanism which at least partly surrounds the operating element rotation axis.

5. The machine tool device according to claim 1, wherein the clamping unit is configured to be released by an actuation travel of the operating element along the protective cover of at least 40°.

6. The machine tool device according to claim 1, wherein the clamping unit is configured to be released by an actuation travel of the operating element along the protective cover by a maximum of 75°.

7. Machine The machine tool device according to claim 5, wherein the actuation travel has an idle travel of at least 20°.

8. The machine tool device according to claim 1, wherein the operating element, viewed in the radial direction, is arranged on a side of the protective cover facing away from the tool holder region.

9. The machine tool device according to claim 1, further comprising a securing unit configured to block the actuation unit when the protective cover is at least partly open.

10. The machine tool device according to claim 1, wherein the operating element is arranged in a fastened state of the clamping unit on a side of the protective cover facing away from an operating side.

11. The machine tool device according to claim 1, wherein the protective cover has at least one upper part of the protective cover and one lower part of the protective cover, which is arranged rotatably relative to the upper part of the protective cover about a protective cover rotation axis.

12. The machine tool device according to claim 2, wherein the protective cover rotation axis is arranged at a distance from and at least essentially parallel to the operating element rotation axis.

13. A machine tool comprising the machine tool device according to claim 1.

14. A system, comprising:
a tool, and
the machine tool according to claim 13.

15. The machine tool device according to claim 1, wherein the machine tool device is a hand-held circular saw device.

16. The machine tool device according to claim 1, wherein the tool is a circular saw blade.

17. The machine tool device according to claim 5, wherein the clamping unit is configured to be released by the actuation travel of the operating element along the protective cover by a maximum of 75°.
